(19) United States
(12) Patent Application Publication
(10) Pub. No.: US 2016/0162176 A1
(43) Pub. Date: Jun. 9, 2016

(54) Method, Device, System and Non-transitory Computer-readable Recording Medium for Providing User Interface

(71) Applicant: FuturePlay, Inc., Seoul (KR)

(72) Inventor: Sung Jae HWANG, Seoul (KR)

(21) Appl. No.: 14/872,501

(22) Filed: Oct. 1, 2015

Related U.S. Application Data
(63) Continuation of application No. PCT/KR2015/008225, filed on Aug. 6, 2015.

(30) Foreign Application Priority Data
Dec. 5, 2014 (KR) 10-2014-0174233

(51) Int. Cl. G06F 3/0488; G09G 5/38; G06F 1/16; G06F 3/0484

(52) U.S. Cl. CPC G06F 3/04883; G06F 3/0484; G09G 5/38; G06F 1/163; G09G 2354/00; G09G 2340/0492; G09G 2340/0464

(57) ABSTRACT

According to one aspect of the present invention, there is provided a method for providing a user interface, comprising the steps of: acquiring information on a trace of a user operation inputted to a device; and controlling a reference coordinate system applied to a user interface provided in the device, with reference to a relative relationship between a first direction specified by the trace of the user operation and a second direction specified by the reference coordinate system.

### PRIORITY CLAIM

This application is a continuation application of Patent Cooperation Treaty (PCT) international application Serial No. PCT/KR2015/008225, filed on Aug. 6, 2015, and which designates the United States, which claims the benefit of the filing date of Korean Patent Application Serial No. 10-2014-0174233, filed on Dec. 5, 2014. The entirety of both PCT international application Serial No. PCT/KR2015/008226 and Korean Patent Application Serial No. 10-2014-0174233 are incorporated herein by reference.

### FIELD

The present invention relates to a method, device, system and non-transitory computer-readable recording medium for providing a user interface.

### BACKGROUND

Recently, mobile smart devices having various communication and sensing capabilities and powerful computing capabilities, such as smart phones and smart pads, are being widely used. Among such mobile smart devices, there are relatively small-sized ones that may be worn and carried on a body of a user (e.g., a smart glass, a smart watch, a smart band, a smart device in the form of a ring or a brooch, a smart device directly worn on or embedded in a body or a garment, etc.)

Particularly, in case of a wearable device such as a smart watch, there may occur a problem that, for example, visual information (e.g., user interface) displayed on a display screen of the wearable device may look slanted according to a position, posture or motion of a body part where the wearable device is worn. However, according to prior art, it has been difficult to solve this problem.

### SUMMARY

One object of the present invention is to fully solve the above problem.

Another object of the invention is to adaptively adjust a display state of a user interface provided in a device by acquiring information on a trace of a user operation inputted to the device, and controlling a reference coordinate system applied to the user interface of the device, with reference to a relative relationship between a first direction specified by the trace of the user operation and a second direction specified by the reference coordinate system.

According to one aspect of the invention to achieve the objects as described above, there is provided a method for providing a user interface, comprising the steps of: acquiring information on a trace of a user operation inputted to a device; and controlling a reference coordinate system applied to a user interface provided in the device, with reference to a relative relationship between a first direction specified by the trace of the user operation and a second direction specified by the reference coordinate system.

According to another aspect of the invention, there is provided a device for providing a user interface, comprising: an input module for acquiring information on a trace of a user operation inputted to the device; and a program module for controlling a reference coordinate system applied to a user interface provided in the device, with reference to a relative relationship between a first direction specified by the trace of the user operation and a second direction specified by the reference coordinate system.

According to yet another aspect of the invention, there is provided a system for providing a user interface, comprising: a control unit for acquiring information on a trace of a user operation inputted to a device, and controlling a reference coordinate system applied to a user interface provided in the device, with reference to a relative relationship between a first direction specified by the trace of the user operation and a second direction specified by the reference coordinate system; and a storage for storing information provided from the device.

In addition, there are further provided other methods, devices and systems to implement the invention, as well as non-transitory computer-readable recording media having stored thereon computer programs for executing the methods.

According to the invention, even if an exterior of a device (e.g., a smart watch) appears to be somewhat slanted from the perspective of a user in a situation in which the user wears the device on a wrist of one hand and inputs a user operation such as a drag operation to a touch panel of the device by the other hand, the above slant may be corrected by adjusting a display state of (i.e., rotating) a user interface provided in the device, so that the appearance of the user interface provided in the device may always appear to be straight from the perspective of the user.

According to the invention, since the slant may be corrected by adjusting the display state of (i.e., rotating) the user interface provided in the device, the intention of the user operation inputted to the user interface of the device may be more accurately reflected without distorting the user operation (e.g., deflecting the direction of the drag operation, reducing the length of the drag operation, etc.)

Further areas of applicability will become apparent from the description provided herein. It should be understood that the description and specific examples are intended for purposes of illustration only and are not intended to limit the scope of the present disclosure.

### DRAWINGS

FIG. 1 schematically shows the configuration of an entire system for providing a user interface according to one embodiment of the invention.

FIGS. 2 to 5 illustratively show how to control a reference coordinate system applied to a user interface of a device and adaptively adjust a display state of the user interface on the basis of a trace of a user operation according to one embodiment of the invention.

FIG. 6 illustratively shows how to rotate a reference coordinate system applied to a user interface of a device according to one embodiment of the invention.

FIG. 7 illustratively shows how to rotate a reference coordinate system on the basis of a position, posture or motion of a device according to one embodiment of the invention.

FIG. 8 illustratively shows various reference coordinate systems that may be applied to a user interface of a device according to one embodiment of the invention.

FIG. 9 illustratively shows how to control a touch region corresponding to a user interface according to one embodiment of the invention.

FIG. 10 illustratively shows how to selectively rotate a graphical element constituting a user interface according to one embodiment of the invention.

The drawings described herein are for illustration purposes only and are not intended to limit the scope of the present disclosure in any way

### DETAILED DESCRIPTION

In the following detailed description of the present invention, references are made to the accompanying drawings that show, by way of illustration, specific embodiments in which the invention may be practiced. These embodiments are described in sufficient detail to enable those skilled in the art to practice the invention. It is to be understood that the various embodiments of the invention, although different from each other, are not necessarily mutually exclusive. For example, specific shapes, structures and characteristics described herein may be implemented as modified from one embodiment to another without departing from the spirit and scope of the invention. Furthermore, it shall be understood that the locations or arrangements of individual elements within each of the disclosed embodiments may also be modified without departing from the spirit and scope of the invention. Therefore, the following detailed description is not to be taken in a limiting sense, and the scope of the invention, if properly described, is limited only by the appended claims together with all equivalents thereof. In the drawings, like reference numerals refer to the same or similar functions throughout the several views.

Hereinafter, preferred embodiments of the present invention will be described in detail with reference to the accompanying drawings to enable those skilled in the art to easily implement the invention.

Configuration of an Entire System

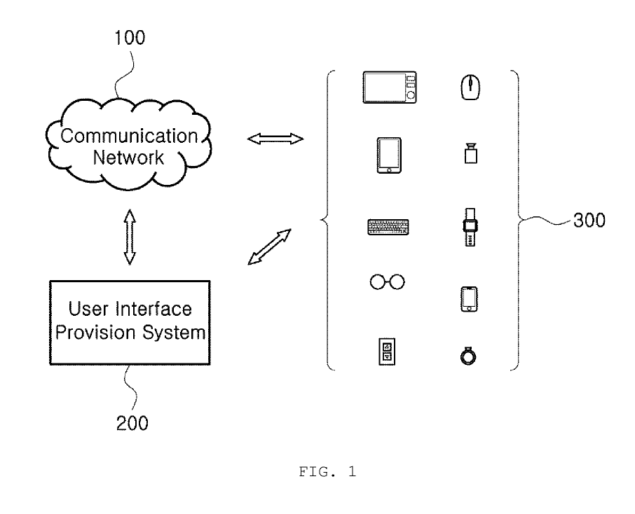

FIG. 1 schematically shows the configuration of an entire system for providing a user interface according to one embodiment of the invention.

As shown in FIG. 1, the entire system according to one embodiment of the invention may comprise a communication network 100, a user interface provision system 200, and a device 300.

First, the communication network 100 according to one embodiment of the invention may be implemented regardless of communication modality such as wired and wireless communications, and may be constructed from a variety of communication networks such as local area networks (LANs), metropolitan area networks (MANs), and wide area networks (WANs). Preferably, the communication network 100 described herein may be the Internet or the World Wide Web (WWW). However, the communication network 100 is not necessarily limited thereto, and may at least partially include known wired/wireless data communication networks, known telephone networks, or known wired/wireless television communication networks. Further, the communication network 100 may at least partially include known short-range wireless communication networks such as Wi-Fi, Bluetooth, near field communication (NFC), and remote frequency identification (RFID).

Next, the user interface provision system 200 according to one embodiment of the invention may be digital equipment having a memory means and a microprocessor for computing capabilities. The user interface provision system 200 may be a server system. The user interface provision system 200 may function to transmit or receive information or control commands to or from the device 300 via the communication network 100.

To this end, as will be described in detail below, the user interface provision system 200 may function to adaptively adjust a display state of a user interface provided in the device 300 by acquiring information on a trace of a user operation inputted to the device 300, and controlling a reference coordinate system applied to the user interface of the device 300, with reference to a relative relationship between a first direction specified by the trace of the user operation and a second direction specified by the reference coordinate system.

The provision of the user interface may be performed by a control unit (not shown) included in the user interface provision system 200. The control unit may reside in the user interface provision system 200 in the form of a program module. The program module may be in the form of an operating system, an application program module, or other program modules. Further, the program module may also be stored in a remote storage device that may communicate with the user interface provision system 200. Meanwhile, such a program module may include, but not limited to, a routine, a subroutine, a program, an object, a component, a data structure and the like for performing a specific task or executing a specific abstract data type as will be described below in accordance with the invention.

Further, the user interface provision system 200 may further function to store the information on the trace of the user operation, which is provided from the device 300. Furthermore, the user interface provision system 200 may further function to store information constituting contents or functions provided in the device 300. The storing may be performed by a storage (not shown) included in the user interface provision system 200. The storage encompasses a computer-readable recording medium, and may refer not only to a database in a narrow sense but also to a database in a broad sense including file-system based data records and the like.

The function of the user interface provision system 200 will be discussed in more detail below. Meanwhile, although the user interface provision system 200 has been described as above, the above description is illustrative and it is apparent to those skilled in the art that at least some of the functions or components required for the user interface provision system 200 may be implemented or included in the device 300, as necessary.

Lastly, the device 300 according to one embodiment of the invention is digital equipment that may function to connect to and then communicate with the user interface provision system 200, and any type of digital equipment having a memory means and a microprocessor for computing capabilities may be adopted as the device 300 according to the invention. The device 300 may be a so-called smart device such as a smart phone, a smart pad, a smart glass, a smart watch, a smart band, and a smart ring, or may be a somewhat traditional device such as a desktop computer, a notebook computer, a workstation, a personal digital assistant (PDA), a web pad, a mobile phone, buttons, a mouse, a keyboard, and an electronic pen. Further, the device 300 may be an Internet of Things (IoT) device such as a remote control and a home appliance.

Particularly, according to one embodiment of the invention, the device 300 may include at least one technical means for receiving an operation from a user. Examples of the technical means may include input modules which are commonly known components such as a touch panel, a pointing tool (e.g., a mouse, a stylus, an electronic pen, etc.), a graphical object operable by the user, a keyboard, a toggle switch, a biometrics (like fingerprints) sensor, and the like.

Further, according to one embodiment of the invention, the device 300 may include at least one technical means for acquiring physical information on a posture or motion of the device 300. Examples of the technical means may include sensing modules which are commonly known components such as a motion sensor, an acceleration sensor, a gyroscope, a magnetic sensor, a positioning module (a GPS module, a beacon-based positioning (position identification) module, etc.), a barometer, a camera, and the like.

Furthermore, according to one embodiment of the invention, the device 300 may include a technical means for acquiring physical information on a posture or motion of the device 300 on the basis of biometrics acquired from a body of a user carrying the device 300. Examples of the technical means may include sensing modules such as an electromyogram (EMG) signal measurement apparatus and the like.

Moreover, according to one embodiment of the invention, a distance between the user and the device 300 may be recognized, even without a distance sensor, on the basis of the information on the trace of the user operation inputted to the device 300, as will be described below.

In addition, the device 300 may further include an application program for processing the above information on the user operation or the above physical information to transmit or receive information or control commands to or from the user interface provision system 200, or to generate the information or control commands. The application may reside in the device 300 in the form of a program module. The nature of the program module may be generally similar to that of the aforementioned control unit of the user interface provision system 200. Here, at least a part of the application may be replaced with a hardware or firmware device that may perform a substantially equal or equivalent function, as necessary.

### Embodiments

Hereinafter, specific examples will be discussed in detail wherein the user interface provision system 200 according to the invention provides a user interface in the device 300 according to various embodiments of the invention.

According to one embodiment of the invention, the user interface provision system 200 may acquire information on a trace of a user operation inputted to the device 300, and control a reference coordinate system applied to a user interface provided in the device 300, with reference to a relative relationship between a first direction specified by the trace of the user operation and a second direction specified by the reference coordinate system. Here, the device 300 may be a wearable device such as a smart watch, which is worn on a body part like a wrist of a user and has a touch panel for receiving user operations such as touch and drag operations.

Specifically, according to one embodiment of the invention, the first direction specified by the trace of the user operation inputted to the device 300 may be defined in the reference coordinate system applied to the user interface provided in the device 300. For example, the user operation may be drag operations repeatedly inputted in left and right directions or up and down directions.

Further, according to one embodiment of the invention, the second direction specified by the reference coordinate system may be specified by a horizontal or vertical axis of the reference coordinate system.

Furthermore, according to one embodiment of the invention, the user interface provision system 200 may rotate the reference coordinate system with reference to an angle between the first and second directions.

Moreover, according to one embodiment of the invention, the user interface provision system 200 may specify the first direction on the basis of traces of user operations inputted for a predetermined number of times or more. For example, an average of traces of user operations inputted ten or more times may be specified as the trace of the user operation.

In addition, according to one embodiment of the invention, the user interface provision system 200 may control the reference coordinate system with further reference to information on at least one of a position, posture and motion of the device. For example, the extent to which the reference coordinate system is rotated may be differently controlled for the case in which a user stretches out an arm wearing a smart watch as the device 300 so that the device 300 is far from eyes of the user, and the case in which the user bends the arm so that the device 300 is close to the eyes of the user. Thereby, the reference coordinate system and the user interface according thereto may appear to be aligned straight from the perspective of the user.

Also, according to one embodiment of the invention, the user interface provision system 200 may cause a display state of some of graphical elements included in a user interface displayed on a display screen of the device 300 to be made distinct from that of the other graphical elements, with reference to a distance between the user and the device 300 (or between the eyes of the user and the display screen of the device 300.)

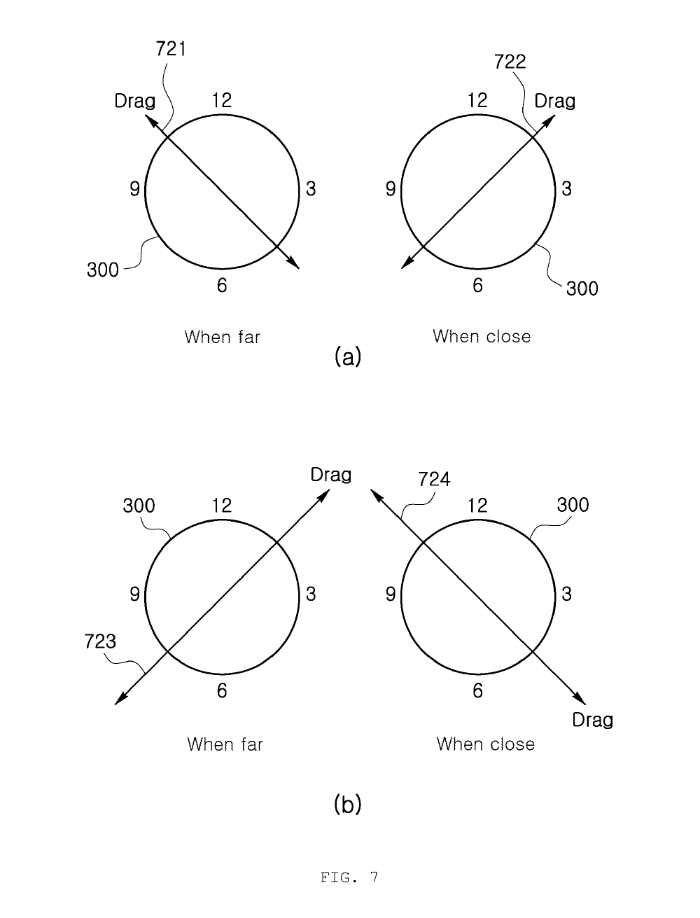

Here, according to one embodiment of the invention, the distance between the user and the device 300 may be recognized (i.e., calculated) on the basis of the information on the trace of the user operation inputted to the device 300. For example, when a user wearing a smart watch as the device 300 on a left wrist stretches out a left hand so that the device 300 is far from the user, a drag operation inputted to the device 300 parallel to a specific axis may be sensed as a drag operation parallel to an axis obtained by rotating the specific axis clockwise by a certain angle, as seen from the perspective of the device. On the basis of the sensing result, the user interface provision system 200 according to one embodiment of the invention may recognize that the device 300 is far from the user (see (a) of FIG. 7). For another example, when a user wearing a smart watch as the device 300 on a left wrist bends a left arm so that the device 300 is close to the user, a drag operation inputted to the device 300 parallel to a specific axis may be sensed as a drag operation parallel to the specific axis or to an axis obtained by rotating the specific axis counterclockwise by a certain angle, as seen from the perspective of the device. On the basis of the sensing result, the user interface provision system 200 according to one embodiment of the invention may recognize that the device 300 is close to the user (see (a) of FIG. 7).

Specifically, according to one embodiment of the invention, when the device 300 is close to the eyes of the user, all graphical elements displayed on the display screen of the device 300 can be shown to the user at a sufficient size without distortion, and thus the user interface provision system 200 may cause all the graphical elements to be evenly displayed over the entire display screen of the device 300, without particular processing.

On the contrary, according to one embodiment of the invention, when the device 300 is far from the eyes of the user, the graphical elements displayed on the display screen of the device 300 can be distorted or shown to the user at a very small size, and thus the user interface provision system 200 may highlight the graphical elements with high importance among those displayed on the display screen of the device 300, in contrast to the other information. For example, important graphical elements such as latest alarms, important alarms, and frequently used icons may be displayed at the bottom of the display screen of the device 300 (i.e., at the positions relatively closer to the eyes of the user), at a relatively large size, or in a relatively conspicuous color.

Further, according to one embodiment of the invention, the user interface provision system 200 may adjust a display state of the user interface provided in the device 300, with reference to the reference coordinate system controlled as above. Here, it should be understood that the user interface encompasses not only a traditional user interface for assisting a user to input an operation or receive necessary information, but also all types of contents that may be visually provided to the user. For example, the user interface provided in the device 300 may be rotated or aligned to be displayed parallel to a horizontal axis of the reference coordinate system.

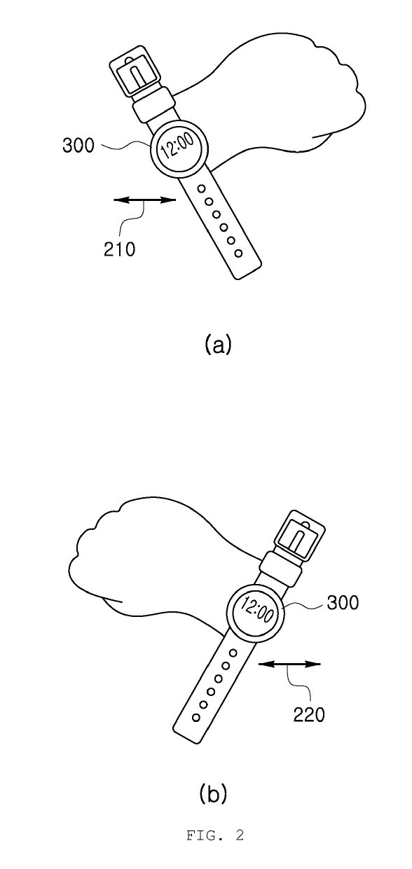

FIGS. 2 to 5 illustratively show how to control a reference coordinate system applied to a user interface of a device and adaptively adjust a display state of the user interface on the basis of a trace of a user operation according to one embodiment of the invention.

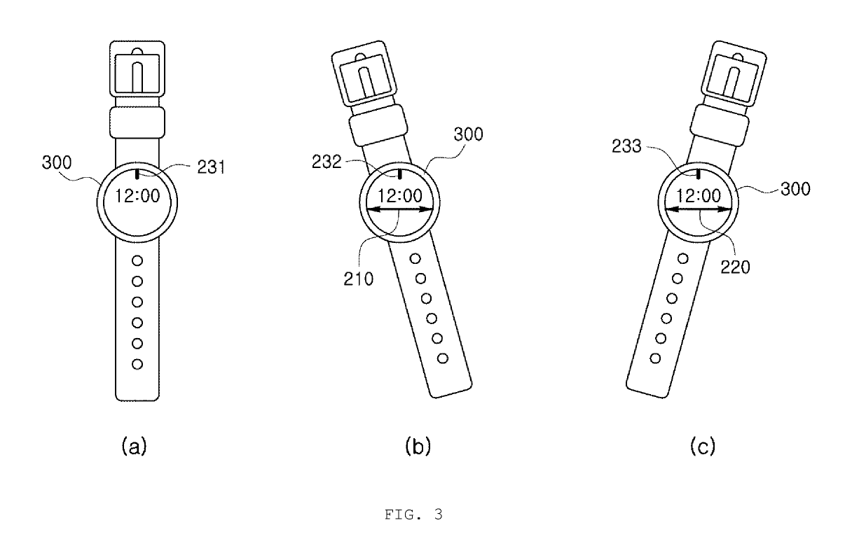

First, referring to FIGS. 2 and 3, it may be assumed that a user wearing a smart watch as the device 300 on a left or right wrist makes drag operations on a touch panel of the device 300 in left and right directions (i.e., the left and right directions as seen or perceived from the perspective of the user.) In this case, there may be a difference between a first direction 210, 220 specified by the user operations and a second direction specified by a reference coordinate system applied to a user interface provided in a display screen of the device 300.

Specifically, referring to (a) of FIG. 3, when no user operation is inputted to the device 300, the user interface provision system 200 according to one embodiment of the invention may adjust a display state of the user interface with reference to a reference coordinate system predetermined on the basis of an exterior of the device 300 or the like. For example, a watch-shaped user interface provided in the device 300 may be displayed as aligned with a predetermined reference coordinate system having a horizontal axis perpendicular to a watch strap (231).

Further, referring to (a) of FIG. 2 and (b) of FIG. 3, when a user wearing the device 300 on a left wrist makes drag operations on the device 300 with a finger of a right hand in left and right directions (i.e., the left and right directions as seen or perceived from the perspective of the user), the first direction 210 may be obtained by rotating the second direction (not shown) clockwise by a certain angle. In this case, the reference coordinate system may be rotated clockwise by the above angle so that the second direction becomes parallel to the first direction. Accordingly, a watch-shaped user interface provided in the device 300 may be displayed as rotated by the angle between the first direction 210 and the second direction (i.e., as appearing to be straight from the perspective of the user) (232).

Furthermore, referring to (b) of FIG. 2 and (c) of FIG. 3, when a user wearing the device 300 on a right wrist makes drag operations on the device 300 with a finger of a left hand in left and right directions (i.e., the left and right directions as seen or perceived from the perspective of the user), the first direction 220 may be obtained by rotating the second direction (not shown) counterclockwise by a certain angle. In this case, the reference coordinate system may be rotated counterclockwise by the above angle so that the second direction becomes parallel to the first direction 220. Accordingly, a watch-shaped user interface provided in the device 300 may be displayed as rotated by the angle between the first direction 220 and the second direction (i.e., as appearing to be straight from the perspective of the user) (233).

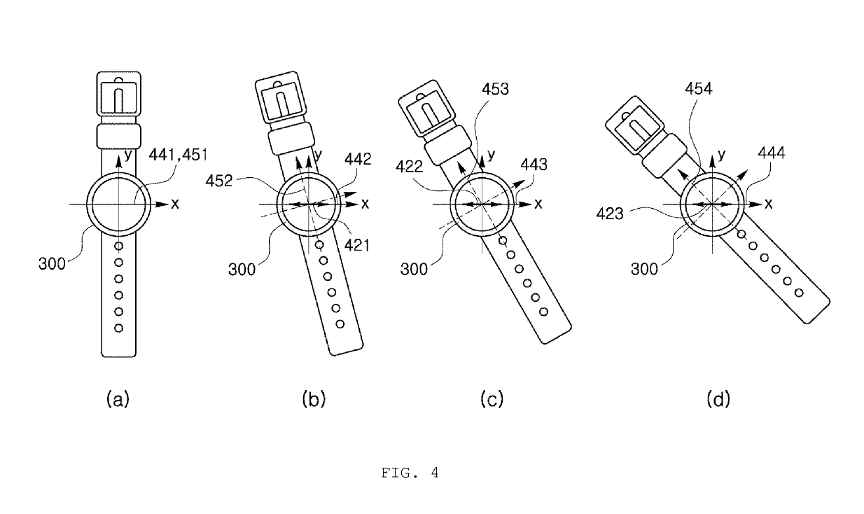

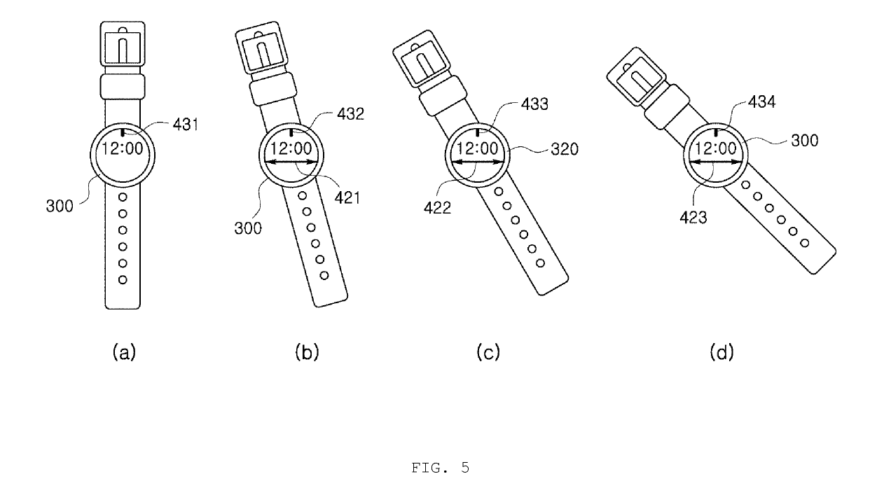

Next, referring to FIGS. 4 and 5, a relative relationship between a first direction 421, 422, 423 and a second direction may vary with a type or direction of a user operation that a user inputs to the device 300, or a position where the user wears the device 300. Accordingly, in correspondence to the variation of the relative relationship (i.e., angular difference) between the first direction 421, 422, 423 and the second direction, the user interface provision system 200 according to one embodiment of the invention may rotate an existing reference coordinate system 442, 443, 444 applied to a user interface 431 of the device 300 by a certain angle to determine a new reference coordinate system 452, 453, 454, and adjust a user interface 432, 433, 434 provided in the device 300 to be displayed as being parallel to the new reference coordinate system 452, 453, 454 determined as above.

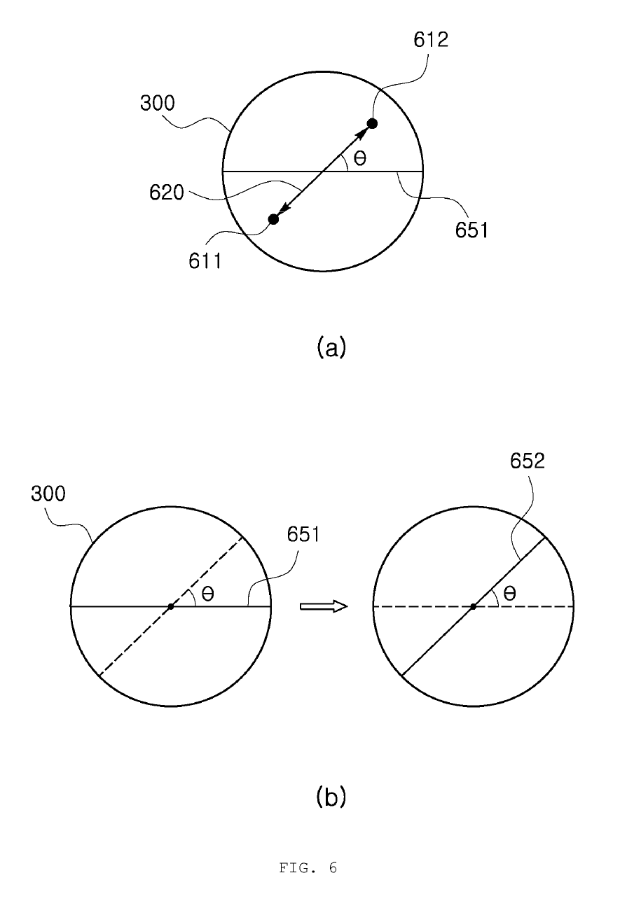

FIG. 6 illustratively shows how to rotate a reference coordinate system applied to a user interface of a device according to one embodiment of the invention.

Referring to FIG. 6, it may be assumed that a user inputs a drag operation 620 passing through a first point 611 and a second point 612 on a touch panel of the device. In this case, a trace of the user operation may be a straight line connecting the first and second points, and an angle between a first direction specified by the trace of the user operation and a second direction specified by a reference coordinate system 651 may be e (see (a) of FIG. 6). Accordingly, the user interface provision system 200 according to one embodiment of the invention may rotate the existing reference coordinate system 651 clockwise by e to determine a new reference coordinate system 652 (see (b) of FIG. 6).

FIG. 7 illustratively shows how to rotate a reference coordinate system on the basis of a position, posture or motion of a device according to one embodiment of the invention.

Referring to FIG. 7, the user interface provision system 200 according to one embodiment of the invention may multiply the above-calculated angle θ between the first and second directions by a certain coefficient to adjust the extent to which the reference coordinate system is rotated. For example, the extent to which the reference coordinate system is rotated may be relatively increased by multiplying the angle θ by a coefficient of 1.15 when a user stretches out an arm wearing a smart watch as the device 300 so that the device 300 is far from eyes of the user, and may be relatively reduced by multiplying the angle θ by a coefficient of 0.55 when the user bends the arm so that the device 300 is close to the eyes of the user. Accordingly, the user interface aligned with the reference coordinate system may appear to be straight from the perspective of the user even when the device 300 is in motion.

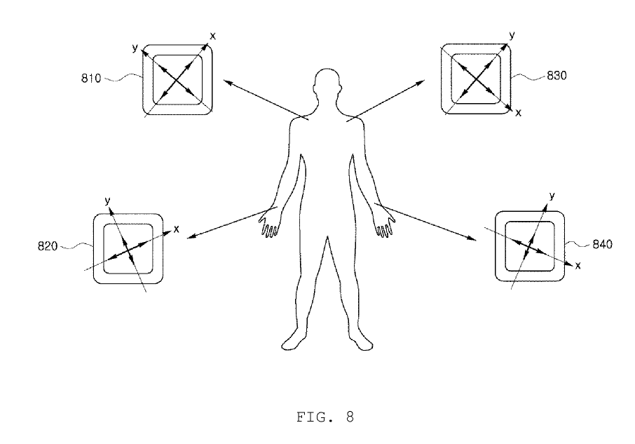

FIG. 8 illustratively shows various reference coordinate systems that may be applied to a user interface of a device according to one embodiment of the invention.

Meanwhile, according to one embodiment of the invention, when a display screen of a user interface is switched according to a user operation such as a drag operation (e.g., a page turn in an e-book, web page, home screen, or the like, scroll movement on a list like a telephone book or a photo album, etc.), the user interface provision system 200 may cause the rotation of the display screen according to that of the reference coordinate system to be made concurrently with the above switching of the display screen, or to be made after the switching of the display screen has been made.

Further, according to one embodiment of the invention, the user interface provision system 200 may control a reference coordinate system applied to a user interface provided in the device 300, with reference to a trace of a user operation inputted to the device 300 within a predetermined time period from when a position or posture change or a motion is sensed in the device 300. When no position or posture change or motion is sensed in the device 300, it is less likely that there is a significant difference between a first direction specified by the trace of the user operation and a second direction specified by the reference coordinate system applied to the user interface provided in the device 300. Accordingly, it is also less likely that there occurs a situation in which the reference coordinate system is to be rotated.

Furthermore, according to one embodiment of the invention, the user interface provision system 200 may rotate the reference coordinate system applied to the user interface provided in the device 300 when the difference between the first direction specified by the trace of the user operation and the second direction specified by the reference coordinate system is equal to or greater than a predetermined threshold value. When the difference between the first and second directions is negligibly small, there is no need to rotate the reference coordinate system to change a display state of the user interface.

Specifically, the user interface provision system 200 according to one embodiment of the invention may determine the above threshold value to be smaller when a position or posture change or a motion is sensed in the device 300 than when no position or posture change or motion is sensed in the device 300. Thereby, when a position or posture change or a motion is sensed in the device 300 and it is expected that the reference coordinate system is more likely to be rotated, the reference coordinate system may be more sensitively controlled.

Further, according to one embodiment of the invention, when a rotation state of the reference coordinate system is adjusted as a user operation is inputted, the user interface provision system 200 may store information on the extent of rotation of the reference coordinate system, and correspondingly store information on a position or posture of the device 300 at the time of adjusting the rotation state of the reference coordinate system. Thereafter, when it is determined that the device 300 takes a certain posture at a certain position, the rotation state of the reference coordinate system may accordingly be adjusted with reference to the stored information, even if no user operation is inputted.

Furthermore, according to one embodiment of the invention, the user interface provision system 200 may awaken the device 300 (or a specific application installed in the device 300) in response to a user operation being inputted to the device 300. Specifically, the user interface provision system 200 according to one embodiment of the invention may awaken the device 300 only when correct biometric information (e.g., fingerprint information, etc.) is inputted in addition to the user operation being inputted.

Moreover, according to one embodiment of the invention, when rotating a display screen of a user interface according to a user operation, the user interface provision system 200 may also rotate a touch region corresponding to the user interface together. Specifically, the user interface provision system 200 according to one embodiment of the invention may rotate the touch region with reference to a size, position, interval and the like of a graphical element corresponding to the touch region. Therefore, according to the invention, a touch-based user operation may be normally inputted even when the display screen of the user interface is rotated.

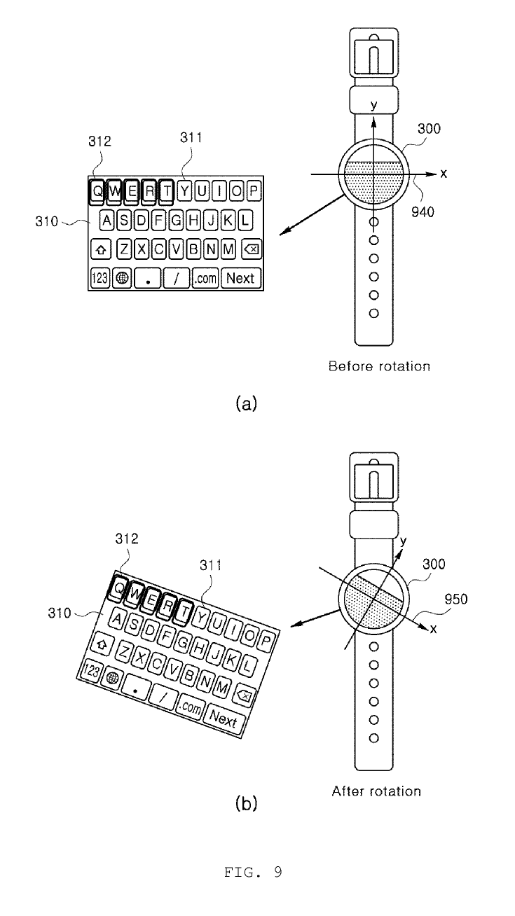

FIG. 9 illustratively shows how to control a touch region corresponding to a user interface according to one embodiment of the invention.

Referring to (a) and (b) of FIG. 9, when a character input interface 310 provided in the device 300 is rotated, a touch region 312 corresponding to each key 311 constituting the character input interface 310 may be rotated together in correspondence to the rotation of the key 311.

Further, according to one embodiment of the invention, when rotating a display screen of a user interface according to a user operation, the user interface provision system 200 may selectively rotate only some of graphical elements constituting the user interface. Specifically, the user interface provision system 200 according to one embodiment of the invention may rotate only the graphical elements operable by a user (e.g. a clock, a character input interface, home screen icons, etc.) or the graphical elements associated with notifications (e.g., those corresponding to message reception, notification display for schedule reminders, applications executed in association with notifications, etc.), without rotating the other graphical elements (e.g., a background screen, etc.) More specifically, the user interface provision system 200 according to one embodiment of the invention may perform image processing (e.g., blurring) on the graphical elements not to be rotated, so that the graphical elements to be rotated may be made clearly distinct from those not to be rotated.

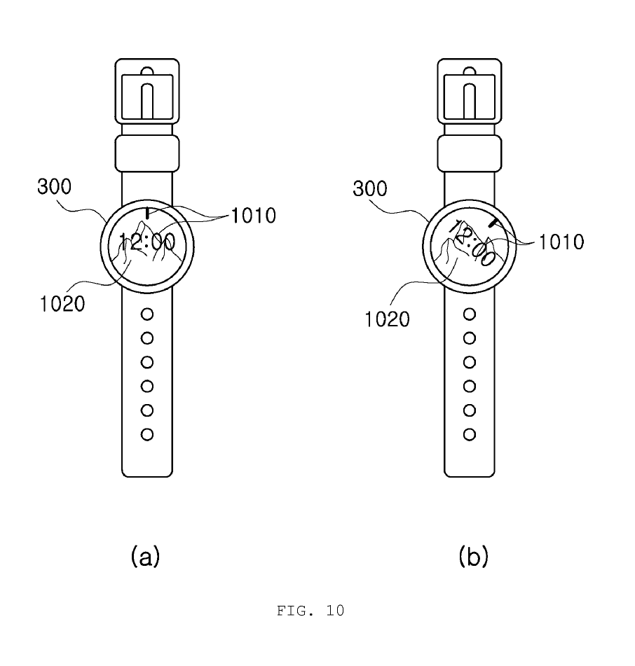

FIG. 10 illustratively shows how to selectively rotate a graphical element constituting a user interface according to one embodiment of the invention.

Referring to (a) and (b) of FIG. 10, among graphical elements constituting a display screen of a user interface provided in the device 300, a graphical element 1010 corresponding to a clock, which needs to be displayed to a user as being straight, may only be rotated while a mountain-shaped graphical element 1020 corresponding to a background screen is not rotated.

Further, according to one embodiment of the invention, the user interface provision system 200 may adaptively control a rotation state of a reference coordinate system, with reference to attributes of a display apparatus provided in the device 300 to output a display screen of a user interface. For example, the user interface provision system 200 according to one embodiment of the invention may adjust the rotation state according to a size of the display apparatus, according to whether the display screen to be rotated is at a front side or a rear side when the display apparatus is a double-sided display, and according to the extent to which the display screen is bent when the display apparatus is a flexible display.

Although the embodiments in which the device is a smart watch worn on a user's wrist have been mainly described above, it is noted that the present invention is not necessarily limited thereto, and the device may also be implemented in any other forms such as a smart pad, a smart glass, a smart band, and a smart ring, as long as the objects of the invention may be achieved.

Further, although the embodiments in which the reference coordinate system applied to the user interface provided in the device 300 is two-dimensional and is rotated only on a plane specified by horizontal and vertical axes have been mainly described above, it is noted that the present invention is not necessarily limited thereto, and it may also be assumed that the reference coordinate system is three-dimensional. When the reference coordinate system is three-dimensional, it may be rotated not only on a plane specified by horizontal and vertical axes, but also on a plane specified by vertical and depth axes or by depth and horizontal axes.

The embodiments according to the invention as described above may be implemented in the form of program instructions that can be executed by various computer components, and may be stored on a non-transitory computer-readable recording medium. The non-transitory computer-readable recording medium may include program instructions, data files, data structures and the like, separately or in combination. The program instructions stored on the non-transitory computer-readable recording medium may be specially designed and configured for the present invention, or may also be known and available to those skilled in the computer software field. Examples of the non-transitory computer-readable recording medium include the following: magnetic media such as hard disks, floppy disks and magnetic tapes; optical media such as compact disk-read only memory (CD-ROM) and digital versatile disks (DVDs); magneto-optical media such as floptical disks; and hardware devices such as read-only memory (ROM), random access memory (RAM) and flash memory, which are specially configured to store and execute program instructions. Examples of the program instructions include not only machine language codes created by a compiler or the like, but also high-level language codes that can be executed by a computer using an interpreter or the like. The above hardware devices may be configured to operate as one or more software modules to perform the processes of the present invention, and vice versa.

Although the present invention has been described in terms of specific items such as detailed elements as well as the limited embodiments and the drawings, they are only provided to help more general understanding of the invention, and the present invention is not limited to the above embodiments. It will be appreciated by those skilled in the art to which the present invention pertains that various modifications and changes may be made from the above description.

Therefore, the spirit of the present invention shall not be limited to the above-described embodiments, and the entire scope of the appended claims and their equivalents will fall within the scope and spirit of the invention.

What is claimed is:

1. A method for providing a user interface, comprising the steps of:
acquiring information on a trace of a user operation inputted to a device; and
controlling a reference coordinate system applied to a user interface provided in the device, with reference to a relative relationship between a first direction specified by the trace of the user operation and a second direction specified by the reference coordinate system.

2. The method of claim 1, wherein the first direction is defined in the reference coordinate system.

3. The method of claim 1, wherein the second direction is specified by at least one of horizontal and vertical axes of the reference coordinate system.

4. The method of claim 1, wherein, in the controlling step, the reference coordinate system is rotated with reference to an angle between the first and second directions.

5. The method of claim 1, wherein the first direction is specified based on the trace of the user operation inputted for a predetermined number of times or more.

6. The method of claim 1, wherein, in the controlling step, the reference coordinate system is controlled with further reference to a distance between a user and the device, which is recognized based on the information on the trace of the user operation.

7. The method of claim 1, wherein the first direction is specified by the trace of the user operation inputted within a predetermined time period from when a motion occurs in the device.

8. The method of claim 1, wherein, in the controlling step, the reference coordinate system is rotated when an angle between the first and second directions is equal to or greater than a predetermined threshold value.

9. The method of claim 8, wherein the predetermined threshold value is determined with reference to whether a motion occurs in the device within a predetermined time period from when the user operation specifying the first direction is inputted.

10. The method of claim 1, wherein, in the controlling step, information on at least one of a position, posture and motion of the device at the time of rotation of the reference coordinate system is stored.

11. The method of claim 1, further comprising the step of:
adjusting a display state of the user interface provided in the device, with reference to the controlled reference coordinate system.

12. The method of claim 11, wherein, in the step of adjusting the display state, a state of at least one touch region corresponding to the user interface is adjusted together with the display state of the user interface.

13. The method of claim 11, wherein, in the step of adjusting the display state, a display state of only some of graphical elements included in the user interface is selectively adjusted.

14. The method of claim 11, wherein, in the step of adjusting the display state, a display state of some of graphical elements included in the user interface is made distinct from that of the other graphical elements, with reference to a distance between a user and the device, which is recognized based on the information on the trace of the user operation.

15. A non-transitory computer-readable recording medium having stored thereon a computer program, the computer program, when executed, causing a processor to implement a method for providing a user interface, the method comprising the steps of:
acquiring information on a trace of a user operation inputted to a device; and
controlling a reference coordinate system applied to a user interface provided in the device, with reference to a relative relationship between a first direction specified by the trace of the user operation and a second direction specified by the reference coordinate system.

16. A device for providing a user interface, comprising:
an input module for acquiring information on a trace of a user operation inputted to the device; and
a program module for controlling a reference coordinate system applied to a user interface provided in the device, with reference to a relative relationship between a first direction specified by the trace of the user operation and a second direction specified by the reference coordinate system.

17. A system for providing a user interface, comprising:
a control unit for acquiring information on a trace of a user operation inputted to a device, and controlling a reference coordinate system applied to a user interface provided in the device, with reference to a relative relationship between a first direction specified by the trace of the user operation and a second direction specified by the reference coordinate system; and
a storage for storing information provided from the device.

18. The system of claim 17, wherein the first direction is defined in the reference coordinate system.

19. The system of claim 17, wherein the second direction is specified by at least one of horizontal and vertical axes of the reference coordinate system.

20. The system of claim 17, wherein the control unit rotates the reference coordinate system with reference to an angle between the first and second directions.

21. The system of claim 17, wherein the first direction is specified based on the trace of the user operation inputted for a predetermined number of times or more.

22. The system of claim 17, wherein the control unit controls the reference coordinate system with further reference to a distance between a user and the device, which is recognized based on the information on the trace of the user operation.

23. The system of claim 17, wherein the first direction is specified by the trace of the user operation inputted within a predetermined time period from when a motion occurs in the device.

24. The system of claim 17, wherein the control unit rotates the reference coordinate system when an angle between the first and second directions is equal to or greater than a predetermined threshold value.

25. The system of claim 24, wherein the predetermined threshold value is determined with reference to whether a motion occurs in the device within a predetermined time period from when the user operation specifying the first direction is inputted.

26. The system of claim 17, wherein the control unit stores information on at least one of a position, posture and motion of the device at the time of rotation of the reference coordinate system.

27. The system of claim 17, wherein the control unit adjusts a display state of the user interface provided in the device, with reference to the controlled reference coordinate system.

28. The system of claim 27, wherein the control unit adjusts a state of at least one touch region corresponding to the user interface together with the display state of the user interface.

29. The system of claim 27, wherein the control unit selectively adjusts a display state of only some of graphical elements included in the user interface.

30. The system of claim 27, wherein the control unit causes a display state of some of graphical elements included in the user interface to be made distinct from that of the other graphical elements, with reference to a distance between a user and the device, which is recognized based on the information on the trace of the user operation.
